(19) United States
(12) Patent Application Publication
(10) Pub. No.: US 2015/0284609 A1
(43) Pub. Date: Oct. 8, 2015

(54) MOISTURE-CURING COMPOSITIONS, PROCESS FOR PRODUCTION THEREOF AND USE THEREOF

(71) Applicants: Thomas SCHLOSSER, (US); Ingo KIEFER, (US); Juergen FRITZ, (US); Regina KRAUSE, (US); Svenja SCHUETT, (US)

(72) Inventors: Thomas Schlosser, Inzlingen (DE); Ingo Kiefer, Schopfheim (DE); Juergen Fritz, Grenzach-Wyhlen (DE); Regina Krause, Rheinfelden (DE); Svenja Schuett, Loerrach (DE)

(73) Assignee: EVONIK INDUSTRIES AG, Essen (DE)

(21) Appl. No.: 14/646,418

(22) PCT Filed: Sep. 25, 2013
(86) PCT No.: PCT/EP2013/069969

§ 371 Date: May 21, 2015

(30) Foreign Application Priority Data
Nov. 22, 2012 (DE) 10 2012 221 375.9

(51) Int. Cl. C09J 175/04; C09J 171/00; C09J 133/08; C09D 171/00; C09D 147/00; C09D 133/08; C09D 183/04; C09D 175/04; C09J 183/04; C09J 147/00

(52) U.S. Cl. CPC C09J 175/04; C09J 183/04; C09J 171/00; C09J 133/08; C09J 147/00; C09D 147/00; C09D 133/08; C09D 183/04; C09D 175/04; C09D 171/00

(57) ABSTRACT

What are described are compositions comprising

a) a polymer modified with at least one silane group (R¹)ₐ(X)_{b}Si— in which X is selected from the group of the R²O—, R²NH—, R²O—CO— and (R²)₂C═N—O— radicals, R¹ and R² are each independently alkyl, cycloalkyl and/or aryl, a is 0, 1 or 2, b is 1, 2 or 3 and the sum total of a and b is 3, and
b) a mixture of catenated and/or cyclic siloxanes of the general formulae I and/or II

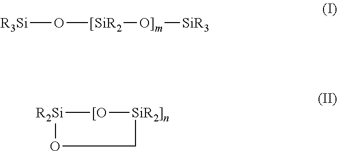

in which the individual R radicals are each independently alkoxy, alkoxyalkoxy, alkyl, alkenyl, cycloalkyl and/or aryl and some of the R radicals are aminoalkyl-functional groups of the formula —CₒH₂ₒ—NH₂, —CₒH₂ₒ—NHR′, —CₒH₂ₒ—NRR′, —CₒH₂ₒ—NH—CₚH₂ₚ—NH₂ or —CₒH₂ₒ—NH—CₚH₂ₚ—NH—C_{q}H_{2q}—NH₂,
in which R′ is alkyl, cycloalkyl or aryl and R takes one of the above definitions or in which R and R′ bonded to a nitrogen atom, together with the common nitrogen atom, form a five- to seven-membered heterocyclic ring,
in which R′ and R take one of the above definitions,
o is independently integers from 1 to 6,
p and q are each independently integers from 2 to 6,
m is an integer from 2 to 30,
n is an integer from 3 to 30, where not more than one aminoalkyl-functional group is bonded to a silicon atom in a compound of the formula I and/or II, and where the quotient of the molar ratio of Si to alkoxy radicals is at least 0.3.
These are of excellent suitability as adhesives and sealants and are notable for improved bonding, especially on substrates that are difficult to bond to one another.

The present invention relates to adhesives and sealants comprising selected bonding agents and selected crosslinkable polymers, to processes for production thereof and to the use thereof, especially for bonding of substrates that are difficult to bond to one another.

Organofunctional silanes have been used successfully for many years to formulate adhesives and sealants. Especially in moisture-crosslinking adhesives and sealants, called reactive adhesives and sealants, for example in silicones or in (alkoxysilane)-terminated polymers such as polyurethanes or polyethers, amino-functional alkoxysilanes have been found to be efficient bonding agents.

Examples of hotmelt adhesives or sealants which postcrosslink under the action of moisture, cure via terminal isocyanate and/or alkoxysilane groups and contain polymers functionalized with aminosilanes can be found in DE 38 40 220 A1.

When amino-functional alkoxysilanes are used as bonding agent, it is possible to improve the adhesion to the substrate to be bonded/sealed. At the same time, cohesion within the adhesive and sealant is also increased. For the sealing/bonding of substrates that are generally difficult to seal or difficult to bond, for example aluminium and plastics, for example polymethylmethacrylate (“PMMA”) and polycarbonate (“PC”), amino-functional alkoxysilanes used as standard, for example aminopropyltrimethoxysilane (Dynasylan® AMMO), usually give only basic adhesion. Therefore, it is necessary in various applications to work (in a preparatory step) with primers.

The problem addressed by the present invention is that of providing compositions which can be used especially as adhesives and sealants, which are easy to use and to measure out, and which give bonds and seals having distinctly improved adhesion to a wide variety of different substrates, for example to metals and plastics. When the inventive compositions are used, it is possible to dispense with the use of a primer.

It has been found that, surprisingly, the use of aminopropyl-functional siloxane oligomers in combination with silane-modified polymers leads to an improvement in adhesion in bonds of moisture-crosslinking adhesives and sealants, for example of silicones or of silane-modified polyurethanes or of silane-modified polyethers, to a wide variety of different substrates, for example to aluminium surfaces or plastic surfaces.

The present invention relates to compositions comprising
a) a polymer modified with at least one silane group (R¹)ₐ(X)_{b}Si— in which X is selected from the group of the R²O—, R²NH—, R²—COO— and (R²)₂C═N—O— radicals, R¹ and R² are each independently alkyl, cycloalkyl and/or aryl, a is 0, 1 or 2, b is 1, 2 or 3 and the sum total of a and b is 3, and
b) a mixture of catenated siloxanes and/or cyclic siloxanes of the general formulae I and/or II

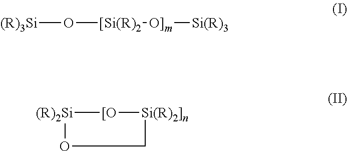

in which the individual R radicals are each independently alkoxy, alkoxyalkoxy, alkyl, alkenyl, cycloalkyl and/or aryl and some of the R radicals are aminoalkyl-functional groups of the formula —CₒH₂ₒ—NH₂, —CₒH₂ₒ—NHR′, —CₒH₂ₒ—NRR′, —CₒH₂ₒ—NH—CₚH₂ₚ—NH₂ or −CₒH₂ₒ—NH—CₚH₂ₚ—NH—C_{q}H_{2q}—NH₂, in which R′ is alkyl, cycloalkyl or aryl and R takes one of the above definitions or in which R and R′ bonded to a nitrogen atom, together with the common nitrogen atom, form a five- to seven-membered heterocyclic ring,
   in which R′ and R take one of the above definitions,
   o is independently integers from 1 to 6,
   p and q are each independently integers from 2 to 6,
   m is an integer from 2 to 30,
   n is an integer from 3 to 30, where
   not more than one aminoalkyl-functional group is bonded to a silicon atom in a compound of the formula I and/or II, and where the quotient of the molar ratio of Si to alkoxy radicals is at least 0.3, especially at least 0.5.

The polymers which have been modified with silane groups and are used as component a) may belong to any desired groups, provided that they have at least one and preferably at least two silane group(s) (R¹)ₐ(X)_{b}Si— per polymer molecule. The silane groups may be attached to different sites in the polymer molecule. They are preferably end groups (=terminal groups) of the polymer and/or non-terminal groups in the structure of the polymer.

The X groups impart the property of moisture crosslinking to the modified polymer. Preferably, the X groups are R²O— radicals.

The alkoxy, amino, hydrocarbylcarboxy, e.g. acetoxy, or oxime radicals which occur in the silane groups of the polymers of component a) may in principle be any desired radicals of this kind having straight-chain or branched alkyl moieties or having other hydrocarbyl radicals. Typically, radicals having short-chain alkyl radicals having up to six carbon atoms, especially having one to three carbon atoms, are used. Particularly preferred examples thereof are N-methylamino, N-ethylamino, acetoxy, N,N-dimethyl oxime, N,N-diethyl oxime, and most preferably methoxy, ethoxy or propoxy.

The alkyl radicals which occur in the silane groups of the polymers of component a) may in principle be any desired straight-chain or branched alkyl radicals. Typically, short-chain alkyl radicals having one to six carbon atoms, especially having one to three carbon atoms, are used. Particularly preferred examples thereof are methyl, ethyl, propyl, butyl, pentyl and hexyl, more preferably methyl or ethyl.

The cycloalkyl radicals which occur in the silane groups of the polymers of component a) may in principle be any desired cycloalkyl radicals. Typically, cycloalkyl radicals having five to eight ring carbon atoms, especially having five to six ring carbon atoms, are used. Particularly preferred examples thereof are cyclopentyl or especially cyclohexyl. The same applies to the cycloalkylamino, cycloalkyloxycarbonyl, cycloalkyl oxime and cycloalkyloxy radicals which occur in the silane groups of the polymers of component a). These radicals may optionally also be substituted, for example by halogen atoms, alkyl groups, hydroxyl groups or amino groups.

The aryl radicals which occur in the silane groups of the polymers of component a) may in principle be any desired carbocyclic or heterocyclic aromatic radicals. Typically, carbocyclic aryl radicals having six to ten ring carbon atoms are used; or heterocyclic aryl radicals having three to eight ring carbon atoms and having one to three ring heteroatoms, for example nitrogen, oxygen or sulphur, are used. Particularly preferred examples of carbocyclic aryl radicals are phenyl or naphthyl. The same applies to the arylamino, aryloxycarbonyl, aryl oxime and aryloxy radicals which occur in the silane groups of the polymers of component a). These radicals may optionally also be substituted, for example by halogen atoms, alkyl groups, hydroxyl groups or amino groups.

The indices a and b, in the case of different silane groups within a polymer molecule, may take different definitions within the scope of the definitions given above. However, the sum total of a and b must always be 3. Preferably, a is 0 or 1 and b is 2 or 3.

In a particularly preferred composition, components a) are used wherein the silane groups are selected from the group of the alkyldialkoxysilane groups and/or the trialkoxysilane groups, especially from the group of methyldimethoxysilane groups and/or trimethoxysilane groups and/or methyldiethoxysilane groups and/or triethoxysilane groups.

Very particular preference is given to compositions wherein the modified polymers a) have terminal or non-terminal alkyldialkoxysilane groups and/or trialkoxysilane groups.

The silane group (R¹)ₐ(X)_{b}Si— in the modified polymers of component a) imparts the property of entering into crosslinking reactions with ingress of moisture to this component. In general, on ingress of moisture, for example of air humidity, depending on the nature of the X group, silicon-oxygen bridges Si—O—Si form with elimination of alcohol R²OH, carboxylic acid R²COOH, oxime (R²)₂C═NOH or amine R²NH₂. This generally occurs with silane groups of different polymers, and so a three-dimensional network forms. These reactions are known to those skilled in the art.

The polymers of component a) are preferably polymers modified with at least one and preferably at least two silane group(s) (R¹)ₐ(X)_{b}Si—, selected from the group of the polyurethanes, polysiloxanes (corresponding to silicones), polyethers, polyacrylates or polybutadienes, especially those which have been modified with at least one silane group (R¹)ₐ(R²O)_{b}Si.

The silane group(s) can be bonded to the polymer structure in a wide variety of different ways. The silicon atom of the silane group may be coupled directly to the polymer structure or via a spacer group, such as an alkylene group. The silane group may be coupled via reactive end groups, for example via vinyl, hydroxyl, amino or isocyanate groups of the polymers, which can be reacted with corresponding reactive groups of the silane group.

For example, it is possible to react polyurethanes terminated with isocyanate groups with aminoalkyltrialkoxysilanes to give a trialkoxysilane-terminated polyurethane. These reactions are known to those skilled in the art and corresponding polymers are commercially available, for example from Bayer MaterialScience AG, Momentive Specialty Chemicals Inc. and Evonik Hansechemie GmbH.

One example of polyethers terminated with silane groups is the MS polymers from Kaneka Corporation.

One example of polyacrylates terminated with silane groups is the XMAP polymers from Kaneka Corporation.

One example of polybutadienes terminated with silane groups is the EPION polymers from Kaneka Corporation.

Examples of polysiloxanes terminated with silane groups are commercially available moisture-crosslinking polysiloxanes from a wide variety of different manufacturers (RTV 1 products).

The functionalized polymers used as component a) are generally liquid at 25° C. and typically have viscosities at 25° C. in the range from 5000 to 1 000 000 mPas, preferably from 10 000 to 50 000 mPas (determined to DIN 53019).

Particularly preferred components a) are polyurethanes which have been modified with silane groups (R¹)ₐ(X)_{b}Si— and have a viscosity at 25° C. of 10 000 to 1 000 000 mPas, preferably of 30 000 to 50 000 mPas (determined to DIN 53019).

The content of silane groups (R¹)ₐ(X)_{b}Si— in the polymer of component a) used in accordance with the invention is typically from 2 to 20, preferably from 4 to 10. For each polymer molecule, an average of two to ten, preferably two to four, silane groups (R¹)ₐ(X)_{b}Si— are present.

The flashpoint of these polymers should if at all possible be >100° C. and the pour point <20° C. Depending on the use, in some cases, transparent, light-coloured, undiscoloured products are required.

The proportion of component a), based on the total amount of the inventive composition, is typically 10% to 99% by weight, preferably 20% to 50% by weight.

The aminoalkyl-functional siloxane oligomers used as component b) in accordance with the invention are in principle compounds as generally also referred to as homo- and co-condensed aminopropyl-functional derivatives of these oligomers, also referred to hereinafter as mixtures for short.

The aminoalkyl-functional siloxane oligomers used as component b) in accordance with the invention are thus advantageously mixtures of catenated and/or cyclic siloxanes of at least one of the general formulae I and/or II

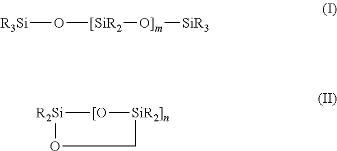

in which the individual R radicals are each independently alkoxy, alkoxyalkoxy, alkyl, alkenyl, cycloalkyl and/or aryl and some of the R radicals are aminoalkyl-functional groups of the formula —CₒH₂ₒ—NH₂, —CₒH₂ₒ—NHR′, —CₒH₂ₒ—NRR′, —CₒH₂ₒ—NH—CₚH₂ₚ— NH₂ or —CₒH₂ₒ—NH—CₚH₂ₚ—NH—C_{q}H_{2q}—NH₂,

in which R′ is alkyl, cycloalkyl or aryl and R takes one of the above definitions or in which R and R′ bonded to a nitrogen atom, together with the common nitrogen atom, form a five- to seven-membered heterocyclic ring,

in which R′ and R take one of the above definitions,

is independently integers from 1 to 6,

p and q are each independently integers from 2 to 6,

m is an integer from 2 to 30,

n is an integer from 3 to 30, where

not more than one aminoalkyl-functional group is bonded to a silicon atom in a compound of the formula I and/or II, and where the quotient of the molar ratio of Si to alkoxy radicals is at least 0.3, especially at least 0.5.

The alkoxy radicals which occur in the compounds of the formulae I and/or II may in principle be any desired alkoxy radicals having straight-chain or branched alkyl moieties. Typically, short-chain alkoxy radicals having up to 6 carbon atoms, especially having one to three carbon atoms, are used. Particularly preferred examples thereof are methoxy, ethoxy or propoxy.

The alkoxyalkoxy radicals which occur in the compounds of the formulae I and/or II may in principle be any desired alkoxyalkoxy radicals having straight-chain or branched alkyl and alkylene moieties. Typically, short-chain alkoxyalkoxy radicals having up to 6 carbon atoms, especially having one to three carbon atoms, are used. Particularly preferred examples thereof are methoxymethoxy, methoxyethoxy or ethoxyethoxy.

The alkyl radicals which occur in the compounds of the formulae I and/or II may in principle be any desired straight-chain or branched alkyl radicals. Typically, alkyl radicals having one to eighteen carbon atoms, especially having one to three carbon atoms, are used. Particularly preferred examples thereof are methyl, ethyl, i- and n-propyl, i- and n-butyl, pentyl, hexyl, i- and n-octyl, decyl, dodecyl, tetradecyl, hexadecyl or octadecyl.

The alkenyl radicals which occur in the compounds of the formulae I and/or II may in principle be any desired straight-chain or branched alkenyl radicals. Typically, short-chain alkenyl radicals having two to six carbon atoms, especially having two or three carbon atoms, are used. Particularly preferred examples thereof are vinyl or allyl.

The cycloalkyl radicals which occur in the compounds of the formulae I and/or II may in principle be any desired cycloalkyl radicals. Typically, cycloalkyl radicals having five to eight ring carbon atoms, especially having five to six ring carbon atoms, are used. Particularly preferred examples thereof are cyclopentyl or especially cyclohexyl. These radicals may optionally also be substituted, for example by halogen atoms, alkyl groups, hydroxyl groups or amino groups.

The aryl radicals which occur in the compounds of the formulae I and/or II may in principle be any desired carbocyclic or heterocyclic aromatic radicals. Typically, carbocyclic aryl radicals having six to ten ring carbon atoms are used; or heterocyclic aryl radicals having three to eight ring carbon atoms and having one to three ring heteroatoms, for example nitrogen, oxygen or sulphur, are used. Particularly preferred examples of carbocyclic aryl radicals are phenyl or naphthyl. These radicals may optionally also be substituted, for example by halogen atoms, alkyl groups, hydroxyl groups or amino groups.

If, in the compounds of the formulae I and/or II, the R and R′ radicals bonded to a nitrogen atom, together with the common nitrogen atom, form a five- to seven-membered heterocyclic ring, this may be an aromatic or nonaromatic heterocycle. Examples of heterocyclic radicals are pyrrole, piperazine, piperidine, pyrrolidine or pyridine. Preference is given to five- or seven-membered heterocycles having two or preferably one ring nitrogen atom(s). These radicals may optionally also be substituted, for example by halogen atoms, alkyl groups, hydroxyl groups or amino groups.

The indices o, p and q within a group may take different definitions within the scope of the definitions given above. Preferably, o is 3 and p and q are each 2.

The proportion of component b), based on the total amount of the inventive composition, is typically 0.1% to 10% by weight, preferably 0.5% to 3% by weight. Aminoalkyl-functional siloxane oligomers used with preference in accordance with the invention are a mixture of catenated and/or cyclic siloxanes of the general formulae I and/or II, where the content of alkoxy groups is between 0.1% and 70% by weight, more preferably between 0.1% and 60% by weight and most preferably between 5% and 50% by weight, based on the weight of the siloxane oligomer mixture.

Aminoalkyl-functional siloxane oligomers used with particular preference in accordance with the invention are a mixture of catenated and/or cyclic siloxanes of the general formulae I and/or II wherein the substituents R are selected (i) from the group of the aminopropyl, aminoethylaminopropyl, aminoethylaminoethylaminopropyl, N-methylaminopropyl, N-(n-butyl)aminopropyl, N-ethylaminoisobutyl, N-cyclohexylaminopropyl, N-cyclohexylaminomethyl, N-phenylaminopropyl, N-pyrrolopropyl, N-(aminophenyl)propyl, N-piperazinopropyl, N-piperidinopropyl, N-pyrrolidinopropyl and/or N-pyridinopropyl radicals and from the group of the (ii) methoxy, ethoxy, 2-methoxyethoxy and/or propoxy group radicals and (iii) optionally from the group of the methyl, vinyl, ethyl, propyl, isobutyl, octyl, hexadecyl or phenyl group radicals, where only one of the radicals from the group (i) may be present per silicon atom.

The aminoalkyl-functional siloxane oligomers used with very particular preference in accordance with the invention include the following catenated and cyclic siloxane oligomers:
3-aminopropyl/n-propyl/alkoxysiloxanes; N-am inoethyl-3-aminopropyl/n-propyl/alkoxysiloxanes; N-butylaminopropyl/methyl/alkoxysiloxanes, where the alkoxy groups are preferably methoxy or ethoxy groups, but ethoxy and methoxy groups may also be present alongside one another;
3-aminopropyl/isobutyl/alkoxysiloxanes; N-aminoethyl-3-aminopropyl/isobutyl/alkoxysiloxanes; N-butylaminopropyl/isobutyl/alkoxysiloxanes, where the alkoxy groups are preferably methoxy or ethoxy groups, but ethoxy and methoxy groups may also be present alongside one another;
3-aminopropyl/n-octyl/alkoxysiloxanes; N-aminoethyl-3-aminopropyl/n-octyl/alkoxysiloxanes; N-butylaminopropyl/n-octyl/alkoxysiloxanes, where the alkoxy groups are preferably methoxy or ethoxy groups, but ethoxy and methoxy groups may also be present alongside one another; and
3-aminopropyl/alkoxysiloxanes; N-aminoethyl-3-aminopropyl/alkoxysiloxanes; N-butylaminopropyl/alkoxysiloxanes, where the alkoxy groups are preferably methoxy or ethoxy groups, but ethoxy and methoxy groups may also be present alongside one another.

Particular preference is given to using, as component b), a mixture of catenated and/or cyclic siloxane oligomers of the formulae I and/or II having a boiling point at pressure 1 atm of greater than 200° C.

Particular preference is given to using, as component b), a mixture of catenated and/or cyclic siloxane oligomers of the formulae I and/or II having a flashpoint of greater than 100° C.

These aminoalkyl-functional siloxane oligomers can generally be prepared as described in EP 0 997 469 A2 or by routine organic chemistry methods. Some of these compounds are commercially available.

Especial preference is given, in an inventive composition, as a particularly advantageous, specific component b), to a mixture at least comprising catenated aminopropyl-functional alkoxysiloxanes of the general formula I and/or cyclic aminopropyl-functional alkoxysiloxanes of the general formula II

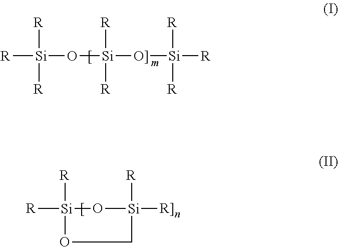

in which the R groups independently consist of
(i) aminopropyl-functional groups of the formulae —(CH₂)₃—NH₂, —(CH₂)₃—NH(CH₂)₂—NH₂ and/or —(CH₂)₃—NH(CH₂)₂—NH(CH₂)₂—NH₂,
(ii) methoxy and/or ethoxy groups and
(iii) optionally butyl or octyl groups,
   m is an integer from 2 to 30 and n is an integer from 3 to 30, where not more than one aminopropyl-functional group is bonded to any silicon atom in a compound of the formula I and II, and
   where the quotient of the molar ratio of Si to alkoxy groups is at least 0.3, preferably ≧0.4, especially ≧0.5.

Especially preferably, the individual R groups in the compounds of the formulae I and II are each independently selected from the group of the 3-aminopropyl, N-(2-aminoethyl)-3-aminopropyl, N-[N′-(2-aminoethyl)-2-aminoethyl]-3-aminopropyl, methoxy, ethoxy, i-butyl, n-butyl, i-octyl, n-octyl radicals.

More particularly, such mixtures are characterized in that the individual R groups in the compounds of the formulae I and II in a mixture of the aminopropyl-functional alkoxysiloxane oligomers are the radicals
3-aminopropyl and methoxy,
3-aminopropyl and ethoxy,
N-(2-aminoethyl)-3-aminopropyl and methoxy,
N-(2-aminoethyl)-3-aminopropyl and ethoxy,
N—[N′-(2-aminoethyl)-2-aminoethyl]-3-aminopropyl and methoxy,
N—[N′-(2-aminoethyl)-2-aminoethyl]-3-aminopropyl and ethoxy,
3-aminopropyl, i-butyl and methoxy,
3-aminopropyl, i-butyl and ethoxy,
N-(2-aminoethyl)-3-aminopropyl, i-butyl and methoxy,
N-(2-aminoethyl)-3-aminopropyl, i-butyl and ethoxy,
N-[N′-(2-aminoethyl)-2-aminoethyl]-3-aminopropyl, i-butyl and methoxy,
N—[N′-(2-aminoethyl)-2-aminoethyl]-3-aminopropyl, i-butyl and ethoxy,
3-aminopropyl, n-butyl and methoxy,
3-aminopropyl, n-butyl and ethoxy,
N-(2-aminoethyl)-3-aminopropyl, n-butyl and methoxy,
N-(2-aminoethyl)-3-aminopropyl, n-butyl and ethoxy,
N—[N′-(2-aminoethyl)-2-aminoethyl]-3-aminopropyl, n-butyl and methoxy,
N—[N′-(2-aminoethyl)-2-aminoethyl]-3-aminopropyl, n-butyl and ethoxy,
3-aminopropyl, i-octyl and methoxy,
3-aminopropyl, i-octyl and ethoxy,
N-(2-aminoethyl)-3-aminopropyl, i-octyl and methoxy,
N-(2-aminoethyl)-3-aminopropyl, i-octyl and ethoxy,
N—[N′-(2-aminoethyl)-2-aminoethyl]-3-aminopropyl, i-octyl and methoxy,
N—[N′-(2-aminoethyl)-2-aminoethyl]-3-aminopropyl, i-octyl and ethoxy,
3-aminopropyl, n-octyl and methoxy,
3-aminopropyl, n-octyl and ethoxy,
N-(2-aminoethyl)-3-aminopropyl, n-octyl and methoxy,
N-(2-aminoethyl)-3-aminopropyl, n-octyl and ethoxy,
N-[N′-(2-aminoethyl)-2-aminoethyl]-3-aminopropyl, n-octyl and methoxy or
N-[N′-(2-aminoethyl)-2-aminoethyl]-3-aminopropyl, n-octyl and ethoxy.

In addition, such mixtures comprising catenated aminopropyl-functional alkoxysiloxanes of the general formula I and/or cyclic aminopropyl-functional alkoxysiloxanes of the general formula II advantageously have a boiling point at pressure 1 atm of greater than 200° C.

Furthermore, such mixtures comprising catenated aminopropyl-functional alkoxysiloxanes of the general formula I and/or cyclic aminopropyl-functional alkoxysiloxanes of the general formula II have a flashpoint of greater than 100° C. Thus, preferred mixtures are generally based essentially on catenated aminopropyl-functional alkoxysiloxanes of the formula I and/or cyclic aminopropyl-functional alkoxysiloxanes of the general formula II, where the content of alkoxy groups is preferably between 0.1% and 70% by weight, more preferably 0.5% to 60% by weight and most preferably 5% to 50% by weight, and the content of free alcohol in the mixture, especially methanol and/or ethanol, is <5% by weight, preferably 0.001% to 3% by weight, more preferably 0.01% to 1% by weight, based on the weight of the aminopropyl-functional alkoxysiloxane oligomer mixture.

For particularly gentle production of such preferred mixtures at least comprising catenated aminopropyl-functional alkoxysiloxanes of the general formula I and/or cyclic aminopropyl-functional alkoxysiloxanes of the general formula II, it is possible with especial preference
to use, as component A, at least one 3-aminopropyl-functional trialkoxysilane, at least one N-(2-aminoethyl)-3-aminopropyl-functional trialkoxysilane and/or at least one N—[N′-(2-aminoethyl)-2-aminoethyl]-3-aminopropyltrialkoxysilane and optionally, as component B, at least one butyltrialkoxysilane or an octyltrialkoxysilane, where alkoxy in each case is methoxy or ethoxy,
to subject components A and optionally B, successively or in a mixture, to controlled hydrolysis and condensation or co-condensation at a temperature of 60 to 80° C., using 0.7 to 1.2 mol of water per 1 mol of Si and 0.1 to 0.5 times the weight of methanol or ethanol, based on the alkoxysilanes used, and
to subsequently remove the alcohol used and the alcohol released in the reaction from the product mixture by distillation at standard pressure or under reduced pressure and a bottom temperature up to 90° C. Especial preference is given to using, as components A and optionally B,
3-aminopropyltrimethoxysilane (AMMO),
3-aminopropyltriethoxysilane (AMEO),
N-(2-aminoethyl)-3-aminopropyltrimethoxysilane (DAMO),
N-(2-aminoethyl)-3-aminopropyltriethoxysilane (DAEO),
N—[N′-(2-aminoethyl)-2-aminoethyl]-3-aminopropyltrimethoxysilane (TRIAMO),
N—[N′-(2-aminoethyl)-2-aminoethyl]-3-aminopropyltriethoxysilane,
3-aminopropyltrimethoxysilane and i-butyltrimethoxysilane (IBTMO),
3-aminopropyltriethoxysilane and i-butyltriethoxysilane (IBTEO),
N-(2-aminoethyl)-3-aminopropyltrimethoxysilane and i-butyltrimethoxysilane,
N-(2-aminoethyl)-3-aminopropyltriethoxysilane and i-butyltriethoxysilane,
N-[N′-(2-aminoethyl)-2-aminoethyl]-3-aminopropyltrimethoxysilane and i-butyltrimethoxysilane,
N—[N′-(2-aminoethyl)-2-aminoethyl]-3-aminopropyltriethoxysilane and i-butyltriethoxysilane,
3-aminopropyltrimethoxysilane and n-butyltrimethoxysilane,
3-aminopropyltriethoxysilane and n-butyltriethoxysilane,
N-(2-aminoethyl)-3-aminopropyltrimethoxysilane and n-butyltrimethoxysilane,
N-(2-aminoethyl)-3-aminopropyltriethoxysilane and n-butyltriethoxysilane,
N-[N′-(2-aminoethyl)-2-aminoethyl]-3-aminopropyltrimethoxysilane and n-butyltrimethoxysilane,
N—[N′-(2-aminoethyl)-2-aminoethyl]-3-aminopropyltriethoxysilane and n-butyltriethoxysilane,
3-aminopropyltrimethoxysilane and i-octyltrimethoxysilane (OCTMO),
3-aminopropyltriethoxysilane and i-octyltriethoxysilane (OCTEO),
N-(2-aminoethyl)-3-aminopropyltrimethoxysilane and i-octyltrimethoxysilane,
N-(2-aminoethyl)-3-aminopropyltriethoxysilane and i-octyltriethoxysilane,
N—[N′-(2-aminoethyl)-2-aminoethyl]-3-aminopropyltrimethoxysilane and i-octyltrimethoxysilane,
N—[N′-(2-aminoethyl)-2-aminoethyl]-3-aminopropyltriethoxysilane and i-octyltriethoxysilane,
3-aminopropyltrimethoxysilane and n-octyltrimethoxysilane (OCTMO),
3-aminopropyltriethoxysilane and n-octyltriethoxysilane (OCTEO),
N-(2-aminoethyl)-3-aminopropyltrimethoxysilane and n-octyltrimethoxysilane,
N-(2-aminoethyl)-3-aminopropyltriethoxysilane and n-octyltriethoxysilane,
N—[N′-(2-aminoethyl)-2-aminoethyl]-3-aminopropyltrimethoxysilane and n-octyltrimethoxysilane or
N—[N′-(2-aminoethyl)-2-aminoethyl]-3-aminopropyltriethoxysilane and n-octyltriethoxysilane.

Advantageously, for the production of component b), components A and B are used in a molar ratio of 1:0 to 1:7, for example 10:1 to 1:6, especially 9:1, 8:1, 7:1, 6:1, 5:1, 4:1, 3:1, 2:1, 1:1, 1:2, 1:3, 1:4, 1:5—to name just a few advantageous use ratios. For performance of said particularly product-conservative process for producing a particularly preferred component b), the procedure may advantageously be as follows:

In general, component(s) A and optionally component B are initially charged. It is also possible to use a mixture of the components in question as the charge. In addition, it is alternatively possible to charge one or both (alkoxysilane) components at least in part and hydrolyse them, preferably partially hydrolyse them, and then to add the remaining amount of the other (alkoxysilane) component(s) and to continue the hydrolysis. The present alkoxysilane mixture is thus advantageously diluted with addition of 0.1 to 0.5 times the weight, preferably 0.11 to 0.3 times the weight, of methanol and/or ethanol, based on the alkoxysilanes used, over a period of up to about 30 minutes. The quantity of alcohol metered in may be aqueous, and the reaction mixture is advantageously mixed. In addition, any quantity of water which is still absent and is part of the quantity calculated for the reaction is metered in, suitably with good mixing, for example while stirring, and likewise over a period of up to about 30 minutes. Thus, a sum total of advantageously 0.7 to 1.2 mol, preferably 0.75, 0.8, 0.85, 0.9, 0.95, 1.0, 1.05, 1.1, 1.15 mol—to name just a few of the intermediate values—of water is used per 1 mol of Si in the alkoxysilanes used. Advantageously, before and/or after the metered addition of alcohol, alcohol/water and/or water, the reaction mixture can be heated, preferably to 60 to 80° C., preferably 60, 62, 64, 66, 68, 70, 72, 74, 76, 78° C.—to name just a few of the intermediate values; the heating can also be effected stepwise or continuously. Subsequently, reaction is allowed to continue while mixing, suitably over a further period of 15 minutes to 5 hours, preferably over 2 to 4 hours. The reaction can alternatively be conducted in the presence of a hydrolysis and condensation catalyst, for example an addition of conc. HCl or aqueous hydrochloric acid or sulphuric acid, to name just a few suitable catalysts, preferably in an amount of 0% to 0.5%, preferably 0.01% to 0.3%, more preferably 0.05% to 0.2% and especially 0.1% by weight of HCl, based on the amount of component(s) A or A and any B, i.e. A and B. The catalyst can be added, for example, together with the diluent, the diluent/water mixture and/or the water. After the reaction, the product mixture thus obtained is worked up by distillation in a particularly gentle manner. This generally virtually fully removes the fraction of methanol and/or ethanol present. Preferably, the distillative workup of the product mixture is conducted at a bottom temperature up to 90° C., preferably at 50 to 85° C., more preferably at 60 to 80° C., at standard pressure, i.e. atmospheric pressure, or under reduced pressure, preferably at a pressure of 400 mbar falling down to 10 mbar. Through the present mode of preparation, it is advantageously possible to produce aminopropyl-functional alkoxysiloxane oligomer mixtures [component b)], which, in the case of co-condensates, for example, have a random distribution or block distribution of [(R)₂Si(O—)_{2/2}] units of different functionality and terminal [—O_{1/2}Si(R)₃] units. In addition, an inventive mixture may alternatively contain branched siloxane oligomers having [(R)Si(O—)_{3/2}] units, i.e. siloxane oligomers containing, as well as what are called M and D structures, T structures as well. The definition of M, D, T and Q structures refers generally to the number of bonded oxygens, as illustrated below for silyl units by way of example:

| | |
|---|---|
| M = monofunctional units | [—O_{1/2}Si(R)₃] |
| D = difunctional units | [(R)₂Si(O—)_{2/2}] |
| T = trifunctional units | [(R)Si(O—)_{3/2}] |
| Q = tetrafunctional units | [Si(O—)_{4/2}] |

Accordingly, in order to be able to give a clearer description of silicones and siloxanes or silane oligomers, it is also possible to use the M, D, T and Q structures rather than an idealized formulaic description. For the more precise nomenclature of the designation of such siloxane structures, reference may be made to Römpp Chemielexikon—entry heading: Silicone. For example, only dimers can be formed from structural units M, with M₂. The construction of chains requires compositions of structural units D and M, and trimers (M₂D), tetramers (M₂D₂) and so on up to linear oligomers with M₂Dₙ can be constructed. The formation of cyclic oligomers requires structural units D. In this way, for example, rings with D₃, D₄, D₅ or higher can be constructed. Branched and/or crosslinked structural elements, under which spiro compounds should also be reckoned, are obtained when structural units T and/or Q are present together. Conceivable crosslinked structures may be present in the form of Tₙ (n≧4), DₙTₘ (m<n), DₙTₘ (n>>m), D₃T₂, M₄Q, D₄Q and so on, to name just a few conceivable possibilities. Structural units M are also referred to as stoppers or transfer agents, while D units are termed chain formers or ring formers, and the T, and possibly also Q, units are referred to as network formers. Thus the use of tetraalkoxysilanes, because of the four hydrolysable groups, and ingress of water and/or moisture, can bring about structural units Q and hence the formation of a network (three-dimensionally crosslinked). In contrast, fully hydrolysed trialkoxysilanes may result in branches, i.e. T units [—Si(—O—)_{3/2}], in a structural element, for example MD₃TM₂ for an oligomer having a degree of oligomerization of n=7, and in these structural representations the respective functionalities on the free valencies of the silyloxy units are to be defined.

Further details on the nomenclature comprehension of M, D, T and Q structures, and also relevant methods of analysis, include the following:
“Strukturuntersuchungen von oligomeren und polymeren Siloxanen durch hochauflösende ²⁹Si-Kernresonanz” [Structural analyses of oligomeric and polymeric siloxanes by high-resolution ²⁹Si nuclear magnetic resonance], H. G. Horn, H. Ch. Marsmann, Die Makromolekulare Chemie 162 (1972), 255-267;
“Über die ¹H-, ¹³C- und ²⁹Si-NMR chemischen Verschiebungen einiger linearer, verzweigter und cyclischer Methyl-Siloxan-Verbindungen” [The ¹H, ¹³C and ²⁹Si NMR chemical shifts of certain linear, branched and cyclic methylsiloxane compounds], G. Engelhardt, H. Jancke; J. Organometal. Chem. 28 (1971), 293-300;
“Chapter 8—NMR spectroscopy of organosilicon compounds”, Elizabeth A. Williams, The Chemistry of Organic Silicon Compounds, 1989 John Wiley & Sons Ltd, 511-533.

The amount of M, D, T or Q structures is determined in general by a method known per se to the skilled person, preferably by means of ²⁹Si NMR.

As well as components a) and b), the inventive composition may comprise further auxiliaries or additives as typically used in adhesives and sealants.

Examples thereof are fillers, pigments or dyes, plasticizers, rheology aids, desiccants, solvents, reactive diluents, adhesive resins, catalysts for the crosslinking reaction of the polymers of component a), UV stabilizers, hydrolysis stabilizers, antioxidants, flame retardants, further adhesion promoters, further additives which impart a particular property to the composition, such as conductivity additives or wetting aids, or mixtures of two or more of these additives.

The proportion of the auxiliaries and additives, based on the total amount of the inventive composition, is typically 1% to 90% by weight, preferably 40% to 80% by weight.

Preferred plasticizers are alkyl phthalates, such as dibutyl phthalate, dioctyl phthalate, benzyl butyl phthalate, dibenzyl phthalate, diisononyl phthalate, diisodecyl phthalate and diundecyl phthalate. Also suitable, however, are the known plasticizers from the group of the organic phosphates, adipates and sebacates, or else benzyl benzoate, liquid polybutenes, dibenzoates or di- or oligopropylene glycols, alkylsulphonates of phenol or cresol, dibenzyltoluene or diphenyl ether. The selection criteria for the plasticizers used with particular preference are guided firstly by the polymer composition and secondly by the viscosity, and also the desired rheological properties of the composition.

It is additionally possible for thixotropic agents to be present in the compositions, for example fumed and precipitated silicas, bentonites, urea derivatives, polyamide waxes, fibrillated short fibres or short pulp fibres, and also colour pastes or pigments.

Moreover, the inventive composition may also include at least one further bonding agent different from the compounds of the formulae I and II. Preference is given to using bonding agents based on organofunctional silanes, for example aminoalkylalkoxysilanes, 3-glycidyloxypropyltrialkoxysilane, 3-mercaptopropyltrialkoxysilane, 3-methacryloyloxypropyltrialkoxysilane, 3-aminopropyltrialkoxysilane, n-aminoethyl-3-aminopropylmethyldialkoxysilane, phenylaminopropyltrialkoxysilane, aminoalkyltrialkoxydisilane, isobutylmethoxysilane or vinyltrialkoxysilane. The alkoxy groups here are generally C1 to C4 alkoxy groups. Additionally suitable as adhesion promoters are, for example, hydrocarbon resins, phenol resins, terpene-phenol resins, resorcinol resins or derivatives thereof, modified or unmodified resin acids or esters thereof (such as abietic acid derivatives), polyamines, polyamine amides, anhydrides or anhydride-containing copolymers.

Useful fillers may be a multitude of materials. For example, it is possible to use chalks, natural ground or precipitated calcium carbonates, calcium magnesium carbonates, silicates of the aluminium magnesium calcium silicate type, for example wollastonite, or barytes and carbon black. It is alternatively possible to use sheet silicates, for example fillers in leaflet form, for example vermiculite, mica or talc.

Pigments and dyes used may be inorganic or organic coloured compounds. Examples of pigments are titanium dioxide or carbon black.

Frequently, mixtures of fillers are used. For example, it is possible to use natural ground chalks in surface-coated form or else uncoated chalks, and also precipitated surface-coated chalks.

In addition to the polymers of component a), the inventive compositions may comprise tackifier resins, which can generally be divided into natural and synthetic resins. Examples of these include the alkyd resins, epoxy resins, melamine resins, phenol resins, urethane resins, hydrocarbon resins, and natural resins such as rosin, wood turpentine oil and tall oil. The synthetic resins include hydrocarbon resins, ketone resins, coumarone-indene resins, isocyanate resins and terpene-phenol resins.

In addition, the inventive compositions may comprise solvents. Suitable solvents are, for example, liquid hydrocarbons.

The inventive adhesives may also comprise defoamers. Examples of these include fatty alcohol-based or silicone-based defoamers.

In addition, the inventive compositions may comprise UV stabilizers and antioxidants. Examples of these are phenols, especially sterically hindered phenols, polyfunctional phenols, sulphur- or phosphorus-containing phenols, amines, especially HALS types. Suitable stabilizers are, for example, hydroquinone, hydroquinone methyl ether, 2,3-(di-tert-butyl)hydroquinone, 1,3,5-trimethyl-2,3,6-tris(3,5-di-tert-butyl-4-hydroxybenzyl)benzene, pentaerythritol tetrakis-3-(3,5-di-tert-butyl-4-hydroxyphenol)propionate, n-octadecyl 3,5-di-tert-butyl-4-hydroxyphenyl)propionate, 4,4-methylenebis(2,6-di-tert-butylphenol), 4,4-thiobis(6-tert-butyl-o-cresol), 2,6-di-tert-butylphenol, 6-(4-hydroxyphenoxy)-2,4-bis(n-octylthio)-1,3,5-triazine, di-n-octacecyl 3,5-di-tert-butyl-4-hydroxybenzylphosphonate, 2-(n-octylthio)ethyl-3,5-di-tert-butyl-4-hydroxybenzoate, sorbitol hexa[3-(3,5-di-tert-butyl-4-hydroxyphenyl)propionate], p-hydroxydiphenylamine, N,N′-diphenylenediamine or phenothiazine.

Suitable UV stabilizers are, for example, benzophenones, benzotriazoles, oxalanilides, phenyltriazines, HALS stabilizers, such as tetramethylpiperidine derivatives, or inorganic compounds such as titanium dioxide, iron oxide pigments or zinc oxide.

Suitable desiccants are, for example, alkoxysilanes such as vinyltrimethoxysilane.

The inventive composition may also comprise catalysts for the crosslinking reaction of the polymers of component a). The person skilled in the art is aware of such catalysts. Examples of these are tin catalysts, for example dialkyltin carboxylates such as dibutyltin dilaurate or dibutyltin distearate. Other examples are amines (e.g. DABCO), and titanium compounds or zirconium compounds (e.g. titanates or zirconates).

The inventive adhesives and sealants can be formulated as one-pack or multipack compositions. Preference is given to producing one-pack formulations or two-pack formulations comprising components A and B. In the case of two-pack formulations, component A preferably comprises the polymer a) and the bonding agent b), and component B preferably comprises the water required for the reaction, for example in the form of an aqueous paste. After production, the formulations are dispensed into airtight vessels, for example into cartridges or into plastic bags, and partly blanketed in these vessels with protective gas (e.g. nitrogen).

The inventive compositions are produced by mixing the individual components with exclusion of moisture. This is known to those skilled in the art, and the mixing can be undertaken, for example, in planetary mixers and dissolvers which are customary in the art. It is possible with preference to work under reduced pressure or under a nitrogen atmosphere.

The invention also relates to a process for producing the above-described composition by mixing components a) and b) with one another with exclusion of moisture.

The inventive adhesives and sealants can be applied from the reservoir vessel(s) manually or with the aid of metering apparatus. The person skilled in the art is aware of the individual variants of the processing of adhesives and sealants.

The inventive adhesives and sealants have very good storage stability when stored with exclusion of moisture and, after application to the substrates to be bonded, cure under the influence of moisture. In general, air humidity is sufficient to bring about the crosslinking of the adhesives and sealants.

The inventive adhesives and sealants have very good processibility and can be processed in a simple manner. After application to the substrates, a skin is formed. At 23° C. and 50% relative air humidity, a skin typically forms within 1 to 200 minutes.

The duration of through-curing depends on factors including the thickness of the adhesive bond desired. Typically, through-curing in a layer of 1 to 5 mm proceeds within 24 hours.

The bonds produced are notable for outstanding mechanical properties and for excellent adhesion. Through-cured bonds typically have moduli of elasticity of 0.2 to 10 N/mm², and tensile strengths of 1 to 10 N/mm², elongations at break of 100% to 1000%, and Shore A hardnesses of 20 to 90.

The invention further relates to the use of the above-described compositions as adhesives and/or as sealants.

Preference is given to producing bonds of wood, glass, metals, painted surfaces, plastics and/or mineral substrates, especially bonds of metal parts and plastic parts, bonds of two or more plastic parts, bonds of wood parts and plastic parts, bonds of glass parts and metal parts and/or plastic parts, bonds of mineral substrates and metals and/or plastic parts, most preferably bonds in which the metal used is aluminium and plastic used is polyolefin, polycarbonate and/or poly(meth)acrylate, preferably polypropylene, polyethylene (which have optionally been pretreated, for example by corona or plasma treatment or by flame treatment of the surface), polyvinyl chloride, polycarbonate and/or polymethylmethacrylate, polystyrene or ABS.

A further preferred use relates to the production of adhesive bonds indoors and outdoors, especially for applications in motor vehicle construction, container construction, appliance manufacture and shipbuilding, in the interior fitout of real estate, facade cladding, roof seals, etc., and in window and door construction.

Most preferably, adhesive bonds are produced in the production of protective glazing, sandwich bonds, lighting covers, lamp holders, switch parts and control knobs, and in window construction.

The inventive compositions are of outstanding suitability for the tension-compensating adhesive bonding of a wide variety of different materials, some of which are difficult to bond to one another, such as wood, glass, metals, plastics and mineral substrates, indoors and outdoors.

The inventive compositions can preferably be used for applications in motor vehicle construction, container construction, appliance manufacture and shipbuilding, but also in the interior fitting of real estate, including “do-it-yourself (DIY)” applications, and in window and door construction.

Use examples of adhesive bonds with aluminium are bonds of roof elements, metal linings, for example sandwich bonds of aluminium, insulation and plastics in cooling container construction and insulation in garage construction, and also the sealing and bonding of ventilation ducts to one another.

Use examples of adhesive bonds with polycarbonate are bonds of skylights, enclosures, for example bicycle racks, shelters, specific windshields, greenhouses, displays and computer monitors.

Use examples of adhesive bonds with polymethylmethacrylate (“PMMA”) are bonds of protective glazing to machinery, and also bullet-proof glass in banks and cash transport vehicles. Sandwich bonds (PMMA in, for example, an aluminium frame), of switchboards, lighting covers, lamp holders, switch parts and control knobs, and in window construction, for example for mobile home windows.

### EXAMPLES

In the use examples which follow, silane-modified polyurethane (ST61 and ST75 from Evonik Hanse GmbH) and a silane-modified polyether (MS polymer S303H from Kaneka Corp.) were used. ST61 was developed for high-modulus applications and had a dynamic viscosity of 35 000 mPas (at 25° C.). This was an aliphatic polyurethane which was clear and colourless.

### Example 1A

### Synthesis of an Aminopropyl-Functional Siloxane Oligomer (Oligomer 1)

A 2 l stirred glass reactor with vacuum, metered addition and distillation equipment was initially charged with 716 g of 3-aminopropyltrimethoxysilane (Dynasylan® AMMO) and 108 g of methanol. The metering apparatus was used to add a mixture of 72 g of water and 80 g of methanol dropwise within 10-30 minutes, in the course of which the reaction mixture warmed up slightly. Subsequently, the mixture was heated to about 70° C. and stirred for 2 hours. After the alcohol had been distilled off under reduced pressure (bottom temperature 50-70° C., pressure 400 mbar falling to 10 mbar), 532 g of a clear, colourless to pale yellowish liquid (oligomer 1) were obtained.

This oligomer was used to produce a test formulation with the silane-terminated polyurethane adhesive ST 61. The ingredients are shown in the next table.

### Example 1B

### Production of the Adhesive Composition

| Component | Reactants for STPU adhesive formulation | Mass [g] |
|---|---|---|
| a) | polymer ST 61 | 365.5 |
| b) | phthalate plasticizer | 145.3 |
| c) | chalk coated with stearic acid | 444.5 |
| d) | AEROSIL ® R 202 | 30.4 |
| e) | Dynasylan ® VTMO | 14.3 |
| f) | amino-functional silane (Dynasylan ® | 11.23 |
| | AMMO as comparative example for | |
| | Example 1C) or siloxane (oligomer 1 | |
| | from Example 1A for Example 1C) | |
| g) | dibutyltin dineodecanoate | 0.61 |

In a planetary mixer, base polymer a) and plasticizer b) were mixed together for 5 minutes. Thereafter, the chalk c) was stirred into the mixture in portions within 10 minutes, and the mixture was homogenized for 40 minutes (evolution of heat). Subsequently, component d) was introduced in portions while stirring within 10 minutes and the mixture was mixed for a further 20 minutes. This preliminary mixture was then cooled to about 40° C. under reduced pressure (about 30 mbar) with reduced stirrer power. After addition of component e) and further mixing (15 minutes), the mixture was degassed at 30 mbar for 5 minutes to give what is called the masterbatch.

For each of the individual performance tests, 100 g of this masterbatch were mixed with 1.12 g of component f) and 0.06 g of component g) in a rotary mixer (SpeedMixer™) for 30 seconds. The ready-formulated adhesive was transferred into a cartridge. The performance tests were effected from the cartridge.

Performance Testing (Test Methods)

The adhesive was tested in accordance with DIN EN ISO 527 and DIN EN 1465 (tear strength, elongation at break, lap shear strength).

### Example 1C

### Use of a Homooligomer of 3-Aminopropyltrimethoxysilane for Improving Adhesion on Aluminium Surfaces

A siloxane oligomer formed from 3-aminopropyltrimethoxysilane was used, which was prepared with 1.0 mol of water/mole of silicon according to Example 1A (=oligomer 1). In the STPU adhesive formulation according to Example 1B, this led to an improved adhesion on the aluminium substrate of about 30% compared to the market standard Dynasylan® AMMO. Other important mechanical indices of the adhesive, such as tensile strength and elongation at break, were not adversely affected.

The 180° tensile shear strength of the aluminium/aluminium adhesive bond in the presence of oligomer 1 in the adhesive was 4.77 N/mm², whereas the comparative strength in the presence of AMMO in the adhesive was 3.71 N/mm².

### Examples 2A to 6A

In analogy to the procedure of Example 1A, further aminopropyl-functional siloxane oligomers were prepared. The materials used and the procedure are detailed in the table below.

| | | | | Addition | Reaction | | | |
|---|---|---|---|---|---|---|---|---|
| | Oligomer | | | time | temperature, | | Distillative | Yield |
| Example | No. | Initial charge | Addition | (min) | time | | removal | (g) |
| 2A | 2 | 178.4 g iso- | 40 g | 5 | 70° | C. | Bottoms: | 579.1 |
| | | butyltrimethoxy- | water, | | 4 | h | 50-70° C. | |
| | | silane, 13.3 g | 40 g | | | | Pressure: | |
| | | water, 0.72 g | methanol | | | | 400 mbar | |
| | | HCl (conc.), 40 | | | | | (falling to | |
| | | g methanol, | | | | | 10 mbar) | |
| | | 537.2 g AMMO | | | | | | |
| 3A | 3 | 716 g AMMO | 86.4 g | 10-30 | 70° | C. | Bottoms: | 495.2 |
| | | 108 g methanol | water, | | 2 | h | 50-70° C. | |
| | | | 80 g | | | | Pressure: | |
| | | | methanol | | | | 400 mbar | |
| | | | | | | | (falling to | |
| | | | | | | | 10 mbar) | |
| 4A | 4 | 178.4 g iso- | 13.3 g | 5 | 70° | C. | Bottoms: | 289.0 |
| | | butyltrimeth- | water, | | 4 | h | 50-70° C. | |
| | | oxysilane, 13.3 | 20 g | | | | Pressure: | |
| | | g water, 0.72 g | methanol | | | | 400 mbar | |
| | | HCl (conc.), | | | | | (falling to | |
| | | 40 g methanol, | | | | | 10 mbar) | |
| | | 179.0 g AMMO | | | | | | |
| 5A | 5 | 889.6 g N- | 86.4 g | 10-30 | 70° | C. | Bottoms: | 668.8 |
| | | aminoethyl-3- | water, | | 2 | h | 50-70° C. | |
| | | aminopropyltri- | 80 g | | | | Pressure: | |
| | | methoxysilane, | methanol | | | | 400 mbar | |
| | | 132 g methanol | | | | | (falling to | |
| | | | | | | | 10 mbar) | |
| 6A | 6 | 178.4 g iso- | 13.3 g | rapid | 70° | C. | Bottoms: | 332.7 |
| | | butyltrimeth- | water, | | 4 | h | 50-70° C. | |
| | | oxysilane, 13.32 | 20 g | | | | Pressure: | |
| | | g water, 0.72 g | methanol | | | | 400 mbar | |
| | | HCl (conc.), 20 | | | | | (falling to | |
| | | g methanol, | | | | | 10 mbar) | |
| | | 222.4 g amino- | | | | | | |
| | | ethyl-3-amino- | | | | | | |
| | | propyltri- | | | | | | |
| | | methoxysilane | | | | | | |

These oligomers were used to produce test formulations with the silane-terminated polyurethane adhesive ST 61 in analogy to Example 1B. The ingredients are shown in the next table.

### Examples 2B to 6B

### Production of the Adhesive Compositions

| | Example No. | | | | |
|---|---|---|---|---|---|
| | 2B | 3B | 4B | 5B | 6B |
| | Mass | Mass | Mass | Mass | Mass |
| Reactants | [g] | [g] | [g] | [g] | [g] |
| Polymer ST61 | 365.5 | 365.5 | 365.5 | 365.5 | 365.5 |
| phthalate | 145.3 | 145.3 | 145.3 | 145.3 | 145.3 |
| plasticizer | | | | | |
| chalk coated | 444.4 | 444.5 | 444.5 | 444.5 | 444.5 |
| with stearic | | | | | |
| acid | | | | | |
| AEROSIL ® | 30.4 | 30.4 | 30.4 | 30.4 | 30.4 |
| R 202 | | | | | |
| Dynasylan ® | 14.3 | 14.3 | 14.3 | 14.3 | 14.3 |
| VTMO | | | | | |
| amino- | 11.23 | 11.23 | 11.23 | 11.23 | 11.23 |
| functional | (oligo- | (oligo- | (oligo- | (oligo- | (oligo- |
| silane | mer 2A) | mer 3A) | mer 4A) | mer 5A) | mer 6A) |
| dibutyltin | 0.61 | 0.61 | 0.61 | 0.61 | 0.61 |
| dineodeca- | | | | | |
| noate | | | | | |

The masterbatch and the ready-formulated adhesive of Examples 2B to 6B were produced as described in Example 1B. The performance tests were effected from the cartridge containing the particular adhesive formulations.

### Examples 2C to 6C

### Performance tests

In analogy to Example 1C, performance tests were conducted. The results are shown in the tables which follow.

| Example | Adhe- | Adhesion to Al or | Elongation at break on | Tensile strength on |
|---|---|---|---|---|
| No. | sive | PC or PMMA*⁾ | Al or PC or PMMA*⁾ | Al or PC or PMMA*⁾ |
| 2C | 2B | 20% improvement | 20% lower than | no change from |
| | | over AMMO (on Al) | AMMO (on Al) | AMMO (on Al) |
| 3C | 3B | 32% improvement | no change from | no change from |
| | | over AMMO (on PC) | AMMO (on PC) | AMMO (on PC) |
| 4C | 4B | 7% improvement | 25% improvement | 8% improvement |
| | | over AMMO (on PC) | over AMMO (on PC) | over AMMO (on PC) |
| 5C | 5B | 165% improvement | no change from | no change from |
| | | over AMMO (on PMMA) | AMMO (on PMMA) | AMMO (on PMMA) |
| 6C | 6B | 25% improvement | 7% improvement | no change from |
| | | over AMMO (on PMMA) | over AMMO (on PMMA) | AMMO (on PMMA) |

| | | 180° tensile | Elongation | Tensile |
|---|---|---|---|---|
| | | shear strength | at break | strength |
| | Adhesive/ | (inventive/in | (inventive/in | (inventive/in |
| Example | adhesive | the presence | the presence | the presence |
| No. | bond*⁾ | of AMMO) | of AMMO) | of AMMO) |
| 2C | 2B/Al/Al | 4.37 N/mm²/ | 200%/ | 3.34 N/mm²/ |
| | | 3.71 N/mm² | 172% | 3.16 N/mm² |
| 3C | 3B/PC/PC | 3.59 N/mm²/ | 157%/ | 3.56 N/mm²/ |
| | | 2.73 N/mm² | 172% | 3.16 N/mm² |
| 4C | 4B/PC/PC | 2.91 N/mm²/ | 215%/ | 3.41 N/mm²/ |
| | | 2.73 N/mm² | 172% | 3.16 N/mm² |
| 5C | 5B/PMMA/ | 3.29 N/mm²/ | not | not |
| | PMMA | 1.25 N/mm² | determined | determined |
| 6C | 6B/PMMA/ | 1.54 N/mm²/ | 183%/ | 3.23 N/mm²/ |
| | PMMA | 1.25 N/mm² | 172% | 3.16 N/mm² |

*⁾Al = aluminium; PC = polycarbonate; PMMA = polymethylmethacrylate

### Examples 7A to 17A

In addition, in analogy to the procedure of example 1A (cf. also Examples 2A to 6A), further inventive aminopropyl-functional siloxane oligomers (co-oligomers) were prepared; the underlying molar ratios of the respective alkoxysilanes used are listed in the table below.

| Example | Oligomer | Component | Component | Molar feedstock |
|---|---|---|---|---|
| No. | No. | A | B | ratio A:B |
| 7A | 7 | AMMO | OCTMO | 1:1 |
| 8A | 8 | AMMO | OCTMO | 3:1 |
| 9A | 9 | AMMO | IBTMO | 1:1 |
| 10A | 10 | AMMO | IBTMO | 3:1 |
| 11A | 11 | DAMO | OCTMO | 1:1 |
| 12A | 12 | DAMO | OCTMO | 3:1 |
| 13A | 13 | TRIAMO | OCTMO | 3:1 |
| 14A | 14 | DAMO | IBTMO | 1:1 |
| 15A | 15 | DAMO | IBTMO | 3:1 |
| 16A | 16 | DAMO | OCTMO | 1:6.5 |
| 17A | 17 | TRIAMO | OCTMO | 1:6.5 |

### Examples 7C to 10C

In further performance tests, in accordance with Example 1C, the bond strength of STPU adhesive formulations in PC/PC adhesive bonds was tested, these having been produced in analogy to Example 1B, in each case using, in place of oligomer 1, an oligomer from the series 7 to 10 and, for comparison, AMMO (monomer) as standard. The results are compiled in the following table:

| Example | Silane or | 180° tensile shear |
|---|---|---|
| No. | oligomer No. | strength [N/mm²] |
| Standard | AMMO | 2.73 |
| 7C | 7 | 3.36 |
| 8C | 8 | 3.18 |
| 9C | 4 | 3.07 |
| 10C | 5 | 3.48 |

### Examples 11C to 15C

In further performance tests, in accordance with Example 1C, the bond strength of STPU adhesive formulations in PMMA/PMMA adhesive bonds was tested, these having been produced in analogy to Example 1B, in each case using, in place of oligomer 1, an oligomer from the series 11 to 15 and, for comparison, AMMO (monomer) as standard. The results are compiled in the following table:

| Example | Silane or | 180° tensile shear |
|---|---|---|
| No. | oligomer No. | strength [N/mm²] |
| Standard | AMMO | 1.25 |
| 11C | 11 | 1.45 |
| 12C | 12 | 2.00 |
| 13C | 13 | 1.52 |
| 14C | 14 | 1.54 |
| 15C | 15 | 1.56 |

### Examples 16C and 17C

In further performance tests, in accordance with Example 1C, the bond strength of STPU sealant formulations in PC/PC adhesive bonds was tested, these having been produced in accordance with Example 1B, in each case using an oligomer from the series 16 to 17 and, for comparison, an oligomer formed from AMMO and PTMO according to EP 0 997 469 A2 as standard; the composition of the STPU sealant formulations is listed in the table below; also compiled in the table that follows thereafter are the results of the performance tests relating thereto:

| Reactants for STPU sealant formulation | Mass [g] |
|---|---|
| Polymer ST 75 | 101.02 |
| phthalate plasticizer | 40.6 |
| chalk coated with stearic acid | 131.32 |
| Dynasylan ® VTMO | 4.2 |
| AMMO/PTMO oligomer as comparative | 2.8 |
| example or oligomer 16 or 17 | |
| dibutyltin dineodecanoate | 0.056 |

| Example | Oligomer | 180° tensile shear |
|---|---|---|
| No. | No. | strength [N/mm²] |
| Standard | AMMO/PTMO | 1.6 |
| | oligomer | |
| 16C | 16 | 2.2 |
| 17C | 17 | 2.2 |

### Examples 18C to 22C

In further performance tests, in accordance with Example 1C, the bond strength of MS adhesive formulations in PC/PC adhesive bonds was tested, these having been produced in accordance with Example 1B, in each case using an oligomer from the series 8, 9, 11, 12, 15 and, for comparison, AMMO (monomer) as standard; the composition of the MS adhesive formulations is listed in the table below; also compiled in the table that follows thereafter are the results of the performance tests relating thereto:

| Reactants for MS adhesive formulation | Mass [g] |
|---|---|
| MS polymer S303H | 65.1 |
| phthalate plasticizer | 47.3 |
| chalk coated with stearic acid | 124.98 |
| AEROSIL ® R 202 | 15.6 |
| Dynasylan ® VTMO | 2.6 |
| Dynasylan ® AMMO as comparative | 3.9 |
| example or oligomer | |
| dibutyltin dineodecanoate | 0.52 |

| Example | Silane or | 180° tensile shear |
|---|---|---|
| No. | oligomer No. | strength [N/mm²] |
| Standard | AMMO | 1.35 |
| 18C | 11 | 1.65 |
| 19C | 8 | 1.71 |
| 20C | 12 | 1.62 |
| 21C | 15 | 1.59 |
| 22C | 9 | 1.83 |

The present performance examples especially demonstrate the surprising advantageous use of inventive functional alkoxysiloxane oligomer mixtures, as can be inferred from Examples 1A to 17A.

1. A composition, comprising;
a) a polymer modified with a silane group (R¹)ₐ(X)_{b}Si— wherein X is selected from the group consisting of R²O—, R²NH—, R²—COO— and (R²)₂C═N—O— radicals, R¹ and R² are each independently alkyl, cycloalkyl and/or aryl, a is 0, 1 or 2, b is 1, 2 or 3 and the sum total of a and b is 3; and
b) a mixture of catenated siloxanes and/or cyclic siloxanes of the general formulae I and/or II 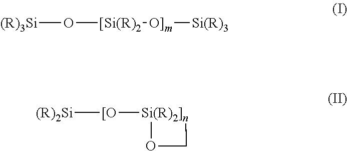
wherein individual R radicals are each independently alkoxy, alkoxyalkoxy, alkyl, alkenyl, cycloalkyl and/or aryl and at least one of the R radicals are aminoalkyl-functional groups of formula —CₒH₂ₒ—NH₂, —CₒH₂ₒ—NHR′, —CₒH₂ₒ—NRR′, —CₒH₂ₒ—NH—CₚH₂ₚ—NH₂ or −CₒH₂ₒ—NH—CₚH₂ₚ—NH—C_{q}H_{2q}—NH₂,
in which R′ is alkyl, cycloalkyl or aryl and R takes one of the above definitions or in which R and R′ bonded to a nitrogen atom, together with the common nitrogen atom, form a five- to seven-membered heterocyclic ring,
is independently integers of from 1 to 6,
p and q are each independently integers of from 2 to 6,
m is an integer of from 2 to 30, and
n is an integer of from 3 to 30,
wherein
not more than one aminoalkyl-functional group is bonded to a silicon atom in a compound of formula I and/or II, and a quotient of a molar ratio of Si to alkoxy radicals is at least 0.3.

2. The composition according to claim 1, wherein when X is R²O, the silane groups of the modified polymer a) are alkyldialkoxysilane groups and/or trialkoxysilane groups.

3. The composition according to claim 2, wherein the modified polymer a) has terminal and/or non-terminal alkyldialkoxysilane groups and/or trialkoxysilane groups.

4. The composition according to claim 1, wherein the modified polymer a) is selected from the group consisting of polyurethanes, polysiloxanes, polyethers, polyacrylates and polybutadienes which have been modified with silane groups (R¹)ₐ(R²O)_{b}Si—.

5. The composition according to claim 1, wherein the individual R radicals in the compounds of formulae I and II are each independently selected from the group consisting of methoxy, ethoxy, propoxy, methoxymethoxy, methoxyethoxy, ethoxyethoxy, methyl, ethyl, i-propyl, n-propyl, i-butyl, n-butyl, pentyl, hexyl, i-octyl, n-octyl, decyl, dodecyl, tetradecyl, hexadecyl, octadecyl, vinyl, allyl, cyclopentyl, cyclohexyl, phenyl and naphthyl radicals.

6. The composition according to claim 1, wherein, in the compounds of formula I and/or II, index o=3 and indices p, q and r are each 2.

7. The composition according to claim 1, wherein the aminoalkyl-functional siloxane oligomers are a mixture of catenated and/or cyclic siloxanes of formulae I and/or II, wherein a content of alkoxy groups is between 0.1% and 70% by weight, based on the weight of the siloxane oligomer mixture.

8. The composition according to claim 1, wherein the aminoalkyl-functional siloxane oligomers are a mixture of catenated and/or cyclic siloxanes of formulae I and/or II wherein the substituents R are at least one selected (i) from the group consisting of aminopropyl, aminoethylaminopropyl, aminoethylaminoethylaminopropyl, N-methylaminopropyl, N-(n-butyl)aminopropyl, N-ethylaminoisobutyl, N-cyclohexylaminopropyl, N-cyclohexylaminomethyl, N-phenylaminopropyl, N-pyrrolopropyl, N-(aminophenyl)propyl, N-piperazinopropyl, N-piperidinopropyl, N-pyrrolidinopropyl and N-pyridinopropyl radicals and from the group consisting of (ii) methoxy, ethoxy, 2-methoxyethoxy and propoxy group radicals and (iii) optionally from the group consisting of methyl, vinyl, ethyl, propyl, butyl, octyl, hexadecyl and phenyl group radicals, where only one of the radicals from the group (i) may be present per silicon atom.

9. The composition according to claim 1, wherein the mixture of catenated and/or cyclic siloxane oligomers of formulae I and/or II has a boiling point at pressure 1 atm of greater than 200° C.

10. The composition according to claim 1, wherein the mixture of catenated and/or cyclic siloxane oligomers of formulae I and/or II has a flashpoint of greater than 100° C.

11. A process for producing a composition according to claim 1, comprising mixing components a) and b) with one another with exclusion of moisture.

12. The process according to claim 11, wherein the component b) is a mixture at least comprising catenated siloxanes and/or cyclic siloxanes of general formulae I and/or II, wherein component b) is produced by a process comprising
employing, as component A, a 3-aminopropyl-functional trialkoxysilane, a N-(2-aminoethyl)-3-aminopropyl-functional trialkoxysilane and/or a N—[N′-(2-aminoethyl)-2-aminoethyl]-3-aminopropyltrialkoxysilane and optionally, as component B, a butyltrialkoxysilane or an octyltrialkoxysilane, wherein alkoxy in each case is methoxy or ethoxy,
subjecting components A and optionally B, successively or in a mixture, to controlled hydrolysis and condensation or co-condensation at a temperature of 60 to 80° C., optionally in the presence of a hydrolysis or condensation catalyst, with 0.7 to 1.2 mol of water per 1 mol of Si and 0.1 to 0.5 times the weight of methanol and/or ethanol, based on the alkoxysilanes used, and
subsequently removing the alcohol employed and the alcohol released in the reaction from the product mixture by distillation at standard pressure or under reduced pressure and a bottom temperature up to 90° C.

13. A process, comprising employing the composition according to claim 1 as adhesives and/or as sealants.

14. The process according to claim 13, wherein bonds of wood, glass, metals, plastics, painted surfaces and/or mineral substrates are produced.

15. The process according to claim 13, wherein the bonds are made indoors and outdoors.

16. The process according to claim 13, wherein the bonds are made in the production of protective glazing, sandwich bonds, lighting covers, lamp holders, switch parts and control knobs, and in window construction.
